(19) United States
(12) Patent Application Publication
(10) Pub. No.: US 2026/0358069 A1
(43) Pub. Date: Nov. 12, 2026

(54) STEAM GENERATOR, METHOD FOR RELIEVING WEAR OF HEAT TRANSFER TUBES THEREOF, AND COMPONENT MOUNTING METHOD

(71) Applicant: SHANGHAI NUCLEAR ENGINEERING RESEARCH & DESIGN INSTITUTE CO., LTD., Shanghai (CN)

(72) Inventors: Quan Zhou, Shanghai (CN); Chang Liu, Shanghai (CN); Ming Jiao, Shanghai (CN); Wei Zhang, Shanghai (CN); Bingbin Ying, Shanghai (CN); Lichen Tang, Shanghai (CN); Mengke Chao, Shanghai (CN); Kai Zhang, Shanghai (CN); Yi Jing, Shanghai (CN); Shaoxuan Lin, Shanghai (CN); Yinbiao He, Shanghai (CN); Changlei Shao, Shanghai (CN); Chen Li, Shanghai (CN); Qiming Men, Shanghai (CN); Xingliang Zhang, Shanghai (CN); Jun Huang, Shanghai (CN); Yangui Yao, Shanghai (CN); Yan You, Shanghai (CN); Yicheng Zhang, Shanghai (CN); Jinghuai Li, Shanghai (CN); Xing Yang, Shanghai (CN)

(21) Appl. No.: 19/111,884

(22) PCT Filed: Aug. 24, 2023
(86) PCT No.: PCT/CN2023/114555

§ 371 Date: Mar. 14, 2025

(30) Foreign Application Priority Data
Sep. 16, 2022 (CN) 202211127714.X

(51) Int. Cl. F28F 13/08; F22B 37/10; F22B 37/26; F28D 7/16; F28F 9/013

(52) U.S. Cl. CPC F28F 13/08; F22B 37/107; F22B 37/26; F28D 7/16; F28F 9/0131

(57) ABSTRACT

The present invention provides a steam generator, a method for relieving wear of a heat transfer tube of the steam generator, and a method for installing a component for relieving wear of the heat transfer tube of the steam generator. The steam generator comprises: a shell; an inner sleeve, which is arranged inside the shell, wherein a descending channel for fluid is formed by an outer side surface of the inner sleeve and an inner side surface of the shell; a heat transfer tube bundle, which is arranged inside the inner sleeve for exchanging heat with the fluid; a primary separator, which is arranged right above the heat transfer tube bundle and the inner sleeve and fixed inside the shell to perform gas-liquid separation on the fluid after heat exchange; and a resistance component, which is arranged at an inlet of the descending channel for buffering the fluid flowing therethrough and reducing a flow rate of the fluid. By means of optimizing and improving the secondary side structure of the steam generator, flow-induced vibration wear of the heat transfer tube bundle caused by an uneven flow field or an excessively high flow rate of the heat transfer tube bundle of the steam generator is reduced, thereby effectively avoiding the occurrence of heat transfer tube bundle ruptures without affecting heat transfer efficiency.

### CROSS-REFERENCE TO RELATED APPLICATION

This application claims the priority of the Chinese patent application No. 202211127714.X, filed on Sep. 16, 2022 and entitled “System and Method for Relieving Wear of Heat transfer tube of Steam generator”, which is incorporated herein by reference in its entirety.

### TECHNICAL FIELD

The present invention relates to the technical field of steam generator.

### BACKGROUND

During the operation of a steam generator of a nuclear power plant, the heat transfer tube bundle often experiences flow-induced vibration due to uneven flow field or excessive flow rate thereof, which causes a certain degree of wear between the heat transfer tube and the support plate or between the heat transfer tube and the anti-vibration strip, and eventually causes the heat transfer tube rupture, which seriously affects the operation safety of the nuclear power plant.

At present, when the wear depth of the heat transfer tube exceeds the limit, the tube is generally treated by a tube blockage. However, a large number of tube blockages will affect the heat exchange efficiency of the steam generator.

### SUMMARY

In view of the problems existing in the prior art, the present invention provides a steam generator, a method for relieving wear of a heat transfer tube of a steam generator, and a method for installing a component for relieving wear of a heat transfer tube of a steam generator. By means of optimizing and improving the structure of the steam generator, flow-induced vibration wear of the heat transfer tube bundle caused by an uneven flow field or an excessively high flow rate of the heat transfer tube bundle of the steam generator is overcome, thereby effectively avoiding the occurrence of heat transfer tube bundle ruptures without affecting heat transfer efficiency.

A first aspect of the present invention provides a steam generator, including:
a shell;
an inner sleeve, which is arranged inside the shell, wherein a descending channel for fluid is formed by an outer side surface of the inner sleeve and an inner side surface of the shell;
a heat transfer tube bundle, which is arranged inside the inner sleeve for exchanging heat with the fluid;
a primary separator, which is arranged right above the heat transfer tube bundle and the inner sleeve and is fixed inside the shell to perform gas-liquid separation on the fluid after heat exchange; and
a resistance component, which is arranged at an inlet of the descending channel for buffering the fluid flowing therethrough and reducing a flow rate of the fluid.

Preferably, a first support plate is provided at bottom of the primary separator, and the resistance component is fixed to a side surface of a circumference of the first support plate.

Preferably, the resistance component includes a plurality of arc-shaped plates, and the plurality of arc-shaped plates are combined to form a circular ring plate which surrounds the circumference of the first support plate.

Preferably, the resistance component is provided with a plurality of first flow holes, and a total flow area of the plurality of first flow holes is between 0.1 and 2 m².

Preferably, the steam generator according to the present invention further includes a flow equalizing component, which is configured for buffering the fluid after heat exchange with the heat transfer tube bundle and reducing the flow rate of the fluid.

Preferably, a second support plate is provided on top of the inner sleeve, and the flow equalizing component is arranged on an upper surface of the second support plate.

Preferably, the flow equalizing component includes a plurality of rectangular slats.

Preferably, the flow equalizing component is provided with a plurality of second flow holes, and a total flow area of the second flow holes is between 0.01 and 0.3 m².

A second aspect of the present invention provides a method for relieving wear of a heat transfer tube of a steam generator, wherein the steam generator includes:
a shell;
an inner sleeve, which is arranged inside the shell, wherein a descending channel for fluid is formed by an outer side surface of the inner sleeve and an inner side surface of the shell;
a heat transfer tube bundle, which is arranged inside the inner sleeve for exchanging heat with the fluid; and
a primary separator, which is arranged right above the heat transfer tube bundle and the inner sleeve and is fixed inside an upper shell to perform gas-liquid separation on the fluid after heat exchange,
wherein the method includes the following step:
arranging a resistance component at an inlet of the descending channel to buffer the fluid flowing therethrough and reduce a flow rate of the fluid.

Preferably, the method for relieving wear of a heat transfer tube of a steam generator according to the present invention further includes the following step:
arranging a flow equalizing component on top of the inner sleeve to buffer the fluid after heat exchange with the heat transfer tube bundle and reduce the flow rate of the fluid.

A third aspect of the present invention provides a method for installing a component for relieving wear of a heat transfer tube of a steam generator, wherein the steam generator includes:
a shell;
an inner sleeve, which is arranged inside the shell, wherein a descending channel for fluid is formed by an outer side surface of the inner sleeve and an inner side surface of the shell;
a heat transfer tube bundle, which is arranged inside the inner sleeve for exchanging heat with the fluid;
a primary separator, which is arranged right above the heat transfer tube bundle and the inner sleeve and fixed inside the shell to perform gas-liquid separation on the fluid after heat exchange, and
a resistance component, which is arranged at an inlet of the descending channel for buffering the fluid flowing therethrough and reducing a flow rate of the fluid, wherein the method includes the following steps:
passing the resistance component into interior of the steam generator through a manhole channel of the steam generator;
passing the resistance component to a position above the inner sleeve through a primary separator manhole at an upper part of the primary separator; and
fixing the resistance component to bottom of the primary separator by welding.

Preferably, in the method for installing a component for relieving wear of a heat transfer tube of a steam generator according to the present invention,
the steam generator further includes a flow equalizing component for buffering the fluid after heat exchange with the heat transfer tube bundle and reducing the flow rate of the fluid,
the method further including the following step:
passing the flow equalizing component into interior of the steam generator through an inspection hole of the steam generator, inserting the flow equalizing component above the heat transfer tube bundle, and fixing the flow equalizing component on top of the inner sleeve.

With the steam generator, the method for relieving wear of the heat transfer tube of the steam generator, and the installation method of the component for relieving wear of the heat transfer tube of the steam generator according to the present invention, by arranging the resistance component at the inlet of the descending channel of the steam generator, the flow area of the descending channel of the steam generator is reduced, the flow resistance of the descending channel is increased, and the secondary side fluid circulation of the steam generator is improved. By means of optimizing and improving the secondary side structure of the steam generator, flow-induced vibration wear of the heat transfer tube bundle caused by an uneven flow field or an excessively high flow rate of the heat transfer tube bundle of the steam generator is overcome, thereby effectively avoiding the occurrence of heat transfer tube bundle ruptures without affecting heat transfer efficiency.

### BRIEF DESCRIPTION OF THE DRAWINGS

In order to illustrate the technical solutions of the embodiments of the present application more clearly, the accompanying drawing to be used in the embodiments of the present application will be briefly introduced below.

FIG. 1 is an overall structural diagram of a steam generator according to a specific embodiment of the present invention;

FIG. 2 is an enlarged view of the portion A in FIG. 1;

FIG. 3 is a top view of a resistance component installed around a first support plate according to a specific embodiment of the present invention;

FIG. 4 is a partial schematic diagram of a flow equalizing component installed on a second support plate according to a specific embodiment of the present invention;

FIG. 5 is a flow chart of a method for relieving wear of a heat transfer tube of a steam generator according to a specific embodiment of the present invention; and

FIG. 6 is a flow chart of a method for installing a component for relieving wear of a heat transfer tube of a steam generator according to a specific embodiment of the present invention.

### REFERENCE NUMERALS

100—Steam generator;
   1—Shell;
      11—Upper shell;
         111—Water supply inlet;
      12—Conical shell;
      13—Lower shell;
   2—Inner sleeve;
      21—Descending channel;
      22—Second support plate;
         221—Heat transfer tube hole;
   3—Heat transfer tube bundle;
      31—Straight tube section;
      32—Elbow section;
   4—Primary separator;
      41—First support plate;
      42—Primary separator manhole;
   5—Resistance component;
      51—Arc-shaped plate;
      52—First flow hole;
   6—Flow equalizing component;
      61—Rectangular slats;
      62—Second flow hole;
   7—Manhole channel;
   8—Inspection hole.

### DETAILED DESCRIPTION

In order to better understand the technical solutions of the present application, the embodiments of the present application will be described in detail below in conjunction with the accompanying drawings.

In view of the problem of wear of the heat transfer tube bundle of the existing steam generator, the present invention provides a steam generator, a method for relieving wear of the heat transfer tube of the steam generator, and a method for installating a component for relieving wear of the heat transfer tube of the steam generator. By arranging a resistance component at the inlet of the descending channel of the steam generator, the flow area of the descending channel of the steam generator is reduced, the flow resistance of the descending channel is increased, and the secondary side fluid circulation of the steam generator is improved.

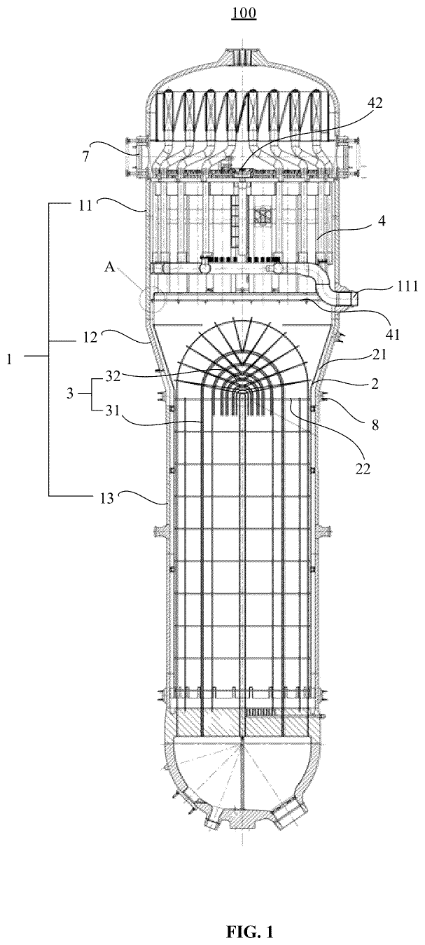

FIG. 1 is an overall structural diagram of a steam generator 100 according to a specific embodiment of the present invention.

As shown in FIG. 1, the steam generator 100 of this embodiment includes a shell 1, an inner sleeve 2, a heat transfer tube bundle 3 and a primary separator 4.

The shell 1 includes an upper shell 11, a conical shell 12 and a lower shell 13. The axes of the upper shell 11, the conical shell 12 and the lower shell 13 coincide with each other; the diameter of the upper shell 11 is larger than that of the lower shell 13; and one end of the conical shell 12 is connected to the upper shell 11, and the other end thereof is connected to the lower shell 13, so that the steam generator 100 has a sealed structure.

The inner sleeve 2 is arranged inside the shell 1, and a descending channel 21 for fluid is formed between the outer side surface of the inner sleeve 2 and the inner side surface of the shell 1.

The heat transfer tube bundle 3 is arranged inside the inner sleeve 2 to exchange heat with the fluid. The heat transfer tube bundle 3 includes a straight tube section 31 and an elbow section 32. In order to clearly show the structure of the present invention, FIG. 1 does not show all the straight tube sections 31.

The primary separator 4 is arranged right above the heat transfer tube bundle 3 and the inner sleeve 2, and is fixed inside the shell 1 to perform gas-liquid separation on the fluid after heat exchange.

In a specific embodiment, the bottom of the primary separator 4 is located inside the upper shell 11 and close to the connection position between the conical shell 12 and the upper shell 11. The top of the inner sleeve 2 is located inside the conical shell 12 and close to the connection position between the conical shell 12 and the upper shell 11.

The upper shell 11 is provided with a water supply inlet 111. The fluid enters the steam generator 100 through the water supply inlet 111, flows to the bottom of the lower shell 13 through the descending channel 21 formed by the outer side surface of the inner sleeve 2 and the inner side surface of the shell 1, and flows into the inner sleeve 2 from the bottom of the lower shell 13. After entering the inner sleeve 2, the fluid exchanges heat with the heat transfer tube bundle 3 to form saturated water vapor. The saturated water vapor rises along the inner sleeve 2 and enters the primary separator 4 which performs gas-liquid separation on the saturated water vapor; the resulting saturated water flows downward and mixes with the water inside the steam generator 100 for the next heating cycle, while the separated steam flows upward to enter the dryer for separation again, and finally flows out of the steam generator 100, so as to complete the secondary side cycle of the steam generator 100.

After flowing to the bottom of the lower shell 13 through the descending channel 21, the fluid enters the inner sleeve 2 to exchange heat with the heat transfer tube bundle 3. Due to the high flow rate of the fluid, the heat transfer tube bundle 3 is easily caused to generate flow-induced vibration, thereby accelerating wear of the heat transfer tube bundle 3.

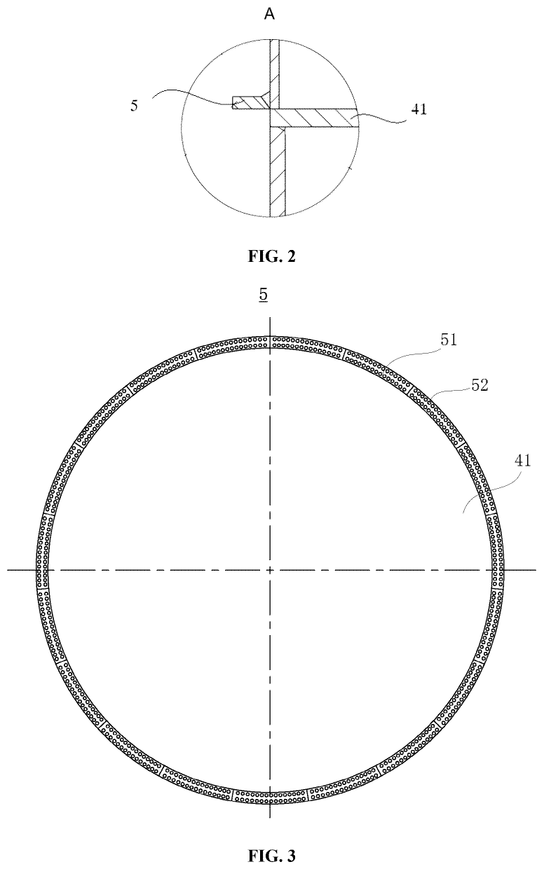

FIG. 2 is an enlarged view of the portion A in FIG. 1.

As shown in FIG. 2, in order to reduce the effect of excessively high flow rate of the fluid on the heat transfer tube bundle 3, a resistance component 5 is arranged at the inlet of the descending channel 21 to buffer the fluid flowing therethrough and reduce the flow rate of the fluid.

A first support plate 41 is arranged at the bottom of the primary separator 4 and used to support the primary separator 4. The first support plate 41 is located above the heat transfer tube bundle 3, and the bottom of the first support plate 41 is connected to the sleeve 2. The resistance component 5 is fixed on the side surface of the circumference of the first support plate 41, so that the resistance component 5 can cover the top of the descending channel 21.

The resistance component 5 is arranged on the first support plate 41, so that it is possible to directly improve the original structure of the existing steam generator 100 while keeping the main body structure of the existing steam generator 100 unchanged, which makes full use of the existing apparatus and saves costs.

FIG. 3 is a top view of the resistance component 5 installed around the first support plate 41 according to a specific embodiment of the present invention. FIG. 3 does not show structures that are not related to the present invention.

As shown in FIG. 3, in a specific embodiment, the resistance component 5 includes a plurality of arc-shaped plates 51, and the plurality of arc-shaped plates 51 are combined to form a circular ring plate surrounding the circumference of the first support plate 41.

The arc-shaped plate 51 may be made of a metal material, and the circular ring plate composed of the plurality of arc-shaped plates 51 may relate to various combination forms. In the circumferential direction, 2 to 30 arc-shaped plates 51 having the same angle or different angles may be included, and these arc-shaped plates 51 are combined into the circular ring plate. For example, when 4 arc-shaped plates 51 are included, these 4 arc-shaped plates 51 may be composed of the same 90° arc-shaped plates 51, or arc-shaped plates 51 are at any angles whose angle sum is 360°, preferably arc-shaped plates 51 having the same angle. In the embodiment shown in FIG. 3, the resistance component 5 includes 19 arc-shaped plates 51 in the circumferential direction, which is only an example and does not limit the present invention.

In the radial direction, 1 to 5 arc-shaped plates 51 of uniform width or non-uniform width may be spliced together, and the total width of the arc-shaped plates 51 in the radial direction is between 25 mm and 90 mm, so as to cover the descending channel 21. The number of the arc-shaped plates 51 in the radial direction depends on the distance between the outer periphery of the first support plate 41 and the inner wall of the shell 1 and the width of the arc-shaped plates 51. In the embodiment shown in FIG. 3, the resistance component 5 includes only one arc-shaped plate 51 in the radial direction, which is only an example and does not limit the present invention.

The resistance component 5 is provided with a plurality of first flow holes 52. The structure form of the first flow holes 52 is not limited, and may be evenly distributed round holes or elongated holes. The total flow area of all the first flow holes 52 is between 0.1 and 2 m², so that the fluid can flow smoothly into the bottom of the lower shell 13, and the flow rate of the fluid can be ensured to be slowed down.

As shown in FIG. 1, the steam generator 100 is provided with a manhole channel 7, which is arranged on the upper shell 11. The manhole channel 7 is used to provide an inspection channel for the steam generator 100 equipment, and maintenance personnel may enter the steam generator 100 through the manhole. The resistance component 5 may be installed on the existing steam generator 100, specifically, the resistance component 5 is passed to a position above the primary separator 4 through the manhole channel 7 of the steam generator 100, and is passed to the outer ring of the first support plate 41 through the primary separator manhole 42, and is directly welded to the outer circumferential surface of the first support plate 41 by a welding manner. The resistance component 5 can change the flow area of the descending channel for fluid, so as to change the overall flow resistance of the secondary side of the steam generator 100 for realizing the change of the secondary side flow field of the steam generator 100 by increasing the resistance, and in turn to reduce the local flow rate and density of the secondary side fluid, thereby reducing the wear degree of the steam generator 100.

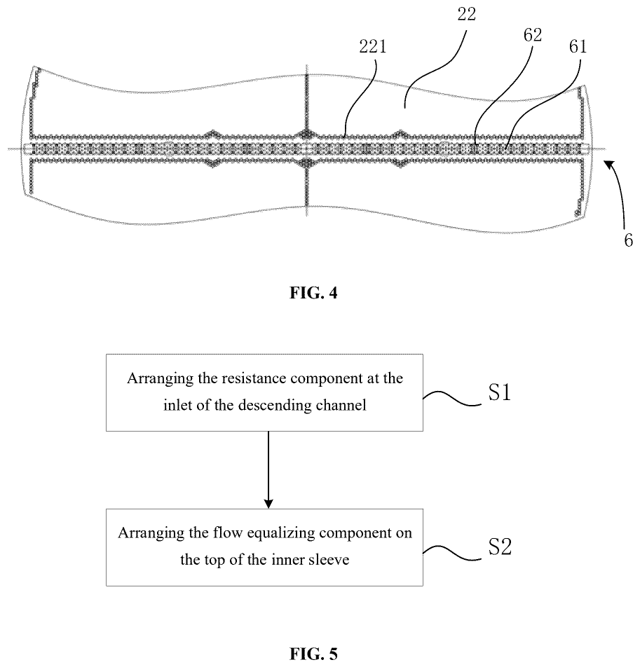

FIG. 4 is a partial schematic diagram of a flow equalizing component 6 installed on a second support plate 22 according to a specific embodiment of the present invention. In order to clearly show the structure of the flow equalizing component 6, FIG. 4 does not fully show the second support plate 22 and the heat transfer tube bundle 3.

As shown in FIG. 4, after the fluid exchanges heat with the heat transfer tube bundle 3 to form water vapor, in order to further relieve the wear of the heat transfer tube bundle 3 due to the water vapor, the flow equalizing component 6 is further provided inside the steam generator 100 to buffer the fluid after heat exchange with the heat transfer tube bundle 3 and reduce the flow rate of the fluid.

As shown in FIG. 4, in a specific embodiment, the second support plate 22 is provided on the top of the inner sleeve 2, and the flow equalizing component 6 is arranged on the upper surface of the second support plate 22.

As shown in FIG. 1, the heat transfer tube bundle 3 includes a straight tube section 31 and an elbow section 32, and the second support plate 22 is located at the upper portion of the straight tube section 31 and the lower portion of the elbow section 32 of the heat transfer tube bundle 3.

As shown in FIG. 4, the second support plate 22 is provided with heat transfer tube holes 221, and the heat transfer tubes of the heat transfer tube bundle 3 pass through the heat transfer tube holes 221. The function of the second support plate 22 is to support the heat transfer tube bundle 3 and provide a flow channel for the fluid.

The flow equalizing component 6 includes a plurality of rectangular slats 61. The rectangular slat 61 may be made of a metal material, and the flow equalizing component 6 composed of the rectangular slats 61 may relate to various combination forms. The rectangular slat 61 may be an entire board or may be formed by splicing slats in the length and width directions. In the length direction, there may be 1 to 30 rectangular slats 61 of uniform length or non-uniform length, and the length of each rectangular slat 61 is between 120 mm and 3900 mm. In the width direction, there may be 1 to 5 rectangular slats 61 of uniform or non-uniform width, and the width is between 5 mm and 110 mm.

A plurality of rectangular slats 61 of different specifications are provided and combined in different forms to cover the upper surface of the second support plate 22, so as to buffer the fluid.

The flow equalizing component 6 is provided with a plurality of second flow holes 62 having a diameter between 2 mm and 18 mm, the flow area of each of the second flow holes is between 3 mm² and 300 mm², the number of the second flow holes is between 100 to 400, and the total flow area of the second flow holes is between 0.01 and 0.3 m². The structural form of the second flow holes 62 is not limited, and may be evenly distributed round holes or elongated holes, so that water vapor may flow smoothly into the primary separator 4 and the flow rate of the fluid can be ensured to be slowed down.

As shown in FIG. 1, the steam generator 100 further includes an inspection hole 8, which is arranged on the shell 1 of the steam generator 100 and located above the side of the second support plate 22. The flow equalizing component 6 can be passed to a position above the second support plate 22 through the inspection hole 8 and inserted into a pipe gallery area above the second support plate 22. The pipe gallery area is located in a middle position of the second support plate 22, is formed as a middle area by portions with the minimum R radius of the heat transfer tube bundle 3, that is, by two straight sections of the innermost heat transfer tubes, and is fixed to the second support plate 22 by rivet nuts.

By arranging the flow equalizing component 6 above the second support plate 22 of the existing steam generator 100, the flow area of the second support plate 22 of the heat transfer tube bundle 3 of the steam generator 100 is reduced, so that the flow of the fluid in this area is not smooth, and the local flow rate of the fluid in this area is slowed down, thereby achieving the effect of relieving the wear of the heat transfer tube.

FIG. 5 is a flow chart of a method for relieving wear of a heat transfer tube of a steam generator according to a specific embodiment of the present invention.

As shown in FIG. 5, in the method for relieving wear of the heat transfer tube of the steam generator according to this embodiment, the steam generator 100 as described above is used to buffer the flow rate of the incoming fluid. The method includes the following steps:

Step S1, the resistance component 5 is arranged at the inlet of the descending channel 21 to buffer the fluid flowing therethrough and reduce the flow rate of the fluid.

The resistance component 5 is arranged above the descending channel 21 formed by the shell 1 and the inner sleeve 2. The fluid enters the steam generator 100 from the water supply inlet 111, flows to the top of the resistance component 5, flows into the descending channel 21 from the resistance component 5, flows to the bottom of the lower shell 13, and then flows into the inner sleeve 2 from the bottom of the lower shell 13. The resistance component 5 is arranged at the inlet of the descending channel 21 to buffer the fluid flowing therethrough and reduce the flow rate of the fluid.

Step S2, the flow equalizing component 6 is arranged at the top of the inner sleeve 2 to buffer the fluid after heat exchange with the heat transfer tube bundle and reduce the flow rate of the fluid.

After flowing to the bottom of the lower shell 13 through the descending channel 21, the fluid enters the inner sleeve 2 to exchange heat with the heat transfer tube bundle 3 to form water vapor. After rising to the top of the inner sleeve 2 inside the inner sleeve 2, the water vapor passes through the flow equalizing component 6 installed on the top of the inner sleeve 2, which reduces the flow area of the second support plate 22 of the heat transfer tube bundle 3 of the steam generator 100, so that the flow of the fluid in this area is not smooth, and the local flow rate of the fluid in this area is slowed down, thereby achieving the effect of relieving the wear of the heat transfer tube. The decelerated fluid flows upwards to enter the primary separator 4 for gas-liquid separation.

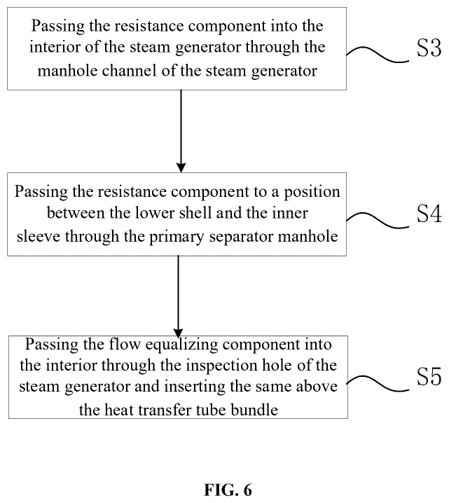

FIG. 6 is a flow chart of a method for installing a component for relieving wear of a heat transfer tube of a steam generator according to a specific embodiment of the present invention.

As shown in FIG. 6, the method for installing a component for relieving wear of a heat transfer tube of a steam generator according to this embodiment makes improvements to an existing steam generator and includes the following steps:
Step S3, the resistance component is passed into the steam generator 100 through the manhole channel 7 of the steam generator 100;
Step S4, the resistance component 5 is passed to a position between the lower shell 13 and the inner sleeve 2 through the primary separator manhole 42 at the upper portion of the primary separator 4; and
the resistance component 5 is fixed to the first support plate 41 at the bottom of the primary separator 4 by welding.

Step S5, the flow equalizing component 6 is passed into the steam generator 100 through the inspection hole 8 of the steam generator, inserted above the heat transfer tube bundle 3, and fixed on the top of the inner sleeve 2.

In the above embodiment, the secondary side structure of the steam generator 100 is improved based on the original steam generator 100, and the internal structure of the steam generator 100 does not need to be changed, thereby improving the versatility of the secondary side structure of the steam generator 100. Of course, the above resistance component 5 and the flow equalizing component 6 may also be directly installed in a newly manufactured steam generator 100 without being limited by the above installation method.

With the steam generator, the method for relieving wear of the heat transfer tube of the steam generator, and the method for installing the component for relieving wear of the heat transfer tube of the steam generator according to the present invention, by arranging the resistance component 6 at the inlet of the descending channel 21 of the steam generator 100, the flow area of the descending channel 21 of the steam generator 100 is reduced, the flow resistance of the descending channel 21 is increased, and the secondary side fluid circulation of the steam generator 100 is improved. By means of optimizing and improving the secondary side structure of the steam generator, flow-induced vibration wear of the heat transfer tube bundle 3 caused by an uneven flow field or an excessively high flow rate of the heat transfer tube bundle 3 of the steam generator 100 is reduced, thereby effectively avoiding the occurrence of heat transfer tube bundle ruptures without affecting heat transfer efficiency.

The above are only preferred embodiments of the present application, and are not intended to limit the present application. For those skilled in the art, the present application may have various modifications and changes. Any modifications, equivalent replacements, improvements, etc. made within the spirit and principles of this application shall be included within the protection scope of this application.

1. A steam generator, comprising:
a shell;
an inner sleeve, which is arranged inside the shell, wherein a descending channel for fluid is formed between an outer side surface of the inner sleeve and an inner side surface of the shell;
a heat transfer tube bundle, which is arranged inside the inner sleeve for exchanging heat with the fluid;
a primary separator, which is arranged right above the heat transfer tube bundle and the inner sleeve and is fixed inside the shell to perform gas-liquid separation on the fluid after heat exchange; and
a resistance component, which is arranged at an inlet of the descending channel for buffering the fluid flowing therethrough and reducing a flow rate of the fluid.

2. The steam generator according to claim 1, wherein a first support plate is provided at bottom of the primary separator, and the resistance component is fixed on a side surface of a circumference of the first support plate.

3. The steam generator according to claim 2, wherein the resistance component is in a circular ring shape, is formed by combining a plurality of arc-shaped plates, and is configured to surround the circumference of the first support plate.

4. The steam generator according to claim 3, wherein the resistance component is provided with a plurality of first flow holes, and a total flow area of the plurality of first flow holes is between 0.1 and 2 m².

5. The steam generator according to claim 1, further comprising: a flow equalizing component, which is configured for buffering the fluid after heat exchange with the heat transfer tube bundle and reducing the flow rate of the fluid.

6. The steam generator according to claim 5, wherein a second support plate is provided on top of the inner sleeve, and the flow equalizing component is arranged on an upper surface of the second support plate.

7. The steam generator according to claim 6, wherein the flow equalizing component comprises a plurality of rectangular slats.

8. The steam generator according to claim 7, wherein the flow equalizing component is provided with a plurality of second flow holes, and a total flow area of the plurality of second flow holes is between 0.01 and 0.3 m².

9. A method for relieving wear of a heat transfer tube of a steam generator, wherein the steam generator comprises:
a shell;
an inner sleeve, which is arranged inside the shell, wherein a descending channel for fluid is formed between an outer side surface of the inner sleeve and an inner side surface of the shell;
a heat transfer tube bundle, which is arranged inside the inner sleeve for exchanging heat with the fluid; and
a primary separator, which is arranged right above the heat transfer tube bundle and the inner sleeve and fixed inside the shell to perform gas-liquid separation on the fluid after heat exchange,
wherein the method comprises the following step:
arranging a resistance component at an inlet of the descending channel to buffer the fluid flowing therethrough and reduce a flow rate of the fluid.

10. The method for relieving wear of a heat transfer tube of a steam generator according to claim 9 further comprising the following step:
arranging a flow equalizing component on top of the inner sleeve to buffer the fluid after heat exchange with the heat transfer tube bundle and reduce the flow rate of the fluid.

11. A method for installing a component for relieving wear of a heat transfer tube of a steam generator, wherein the steam generator comprises:
a shell;
an inner sleeve, which is arranged inside the shell, wherein a descending channel for fluid is formed between an outer side surface of the inner sleeve and an inner side surface of the shell;
a heat transfer tube bundle, which is arranged inside the inner sleeve for exchanging heat with the fluid;
a primary separator, which is arranged right above the heat transfer tube bundle and the inner sleeve and fixed inside the shell to perform gas-liquid separation on the fluid after heat exchange; and
a resistance component, which is arranged at an inlet of the descending channel for buffering the fluid flowing therethrough and reducing a flow rate of the fluid,
wherein the method comprises the following steps:
passing the resistance component into interior of the steam generator through a manhole channel of the steam generator;
passing the resistance component to a position above the inner sleeve through a primary separator manhole at an upper part of the primary separator; and
fixing the resistance component to bottom of the primary separator by welding.

12. The method for installing a component for relieving wear of a heat transfer tube of a steam generator according to claim 11, wherein the steam generator further comprises a flow equalizing component for buffering the fluid after heat exchange with the heat transfer tube bundle and reducing the flow rate of the fluid,
wherein the method further comprises the following step:
passing the flow equalizing component into interior of the steam generator through an inspection hole of the steam generator, inserting the flow equalizing component above the heat transfer tube bundle, and fixing the flow equalizing component on top of the inner sleeve.
